(19) United States
(12) Patent Application Publication
(10) Pub. No.: US 2020/0128790 A1
(43) Pub. Date: Apr. 30, 2020

(54) AUTOMATIC CATTLE WORMER SYSTEM

(71) Applicant: Larry Ledbetter, Dill City, OK (US)

(72) Inventor: Larry Ledbetter, Dill City, OK (US)

(21) Appl. No.: 16/173,067

(22) Filed: Oct. 29, 2018

(51) Int. Cl. A01K 13/00; A61D 7/00; A01K 5/01

(52) U.S. Cl. CPC A01K 13/003; A01K 5/01; A61D 7/00

(57) ABSTRACT

An automatic cattle wormer system to medicate an animal, the automatic cattle wormer system including a base, a vertical post to extend vertically from the base, a horizontal post to extend horizontally from a top portion of the vertical post, the horizontal post including a plurality of spouts disposed on a bottom surface of the horizontal post, a food basin to store food therein, the food basin including two arms extending horizontally from the food basin and being substantially parallel to each other, and a sensor disposed on an inner surface of at least one of the two arms to sense when the animal has entered a space between the two arms, a compound holding box disposed on at least one of the vertical post and the horizontal post to store a deworming compound therein, and a pump to extract the deworming compound from the compound holding box such that the spouts spray the deworming compound out therefrom.

### BACKGROUND

### 1. Field

The present general inventive concept relates generally to an automatic cattle wormer system.

### 2. Description of the Related Art

Parasites associated with common diseases in calves often consist of worms that cause sickness and lice. Currently, on the market, there are products available for killing worms, but there is a lack of devices that aid in applying those products. Specifically, cattle are often unruly when they are sprayed with deworming compounds.

Therefore, there is a need for an automatic cattle wormer system.

### SUMMARY

The present general inventive concept provides an automatic cattle wormer system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an automatic cattle wormer system to medicate an animal, the automatic cattle wormer system including a base, a vertical post to extend vertically from the base, a horizontal post to extend horizontally from a top portion of the vertical post, the horizontal post including a plurality of spouts disposed on a bottom surface of the horizontal post, a food basin to store food therein, the food basin including two arms extending horizontally from the food basin and being substantially parallel to each other, and a sensor disposed on an inner surface of at least one of the two arms to sense when the animal has entered a space between the two arms, a compound holding box disposed on at least one of the vertical post and the horizontal post to store a deworming compound therein, and a pump to extract the deworming compound from the compound holding box such that the spouts spray the deworming compound out therefrom.

The automatic cattle wormer system may further include a processor to receive a signal from the sensor in response to the animal walking between the two arms, and to send another signal to the pump to perform the extraction of the deworming compound from the compound holding box such that the spouts spray the deworming compound out therefrom.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top angled perspective view of an automatic cattle wormer system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

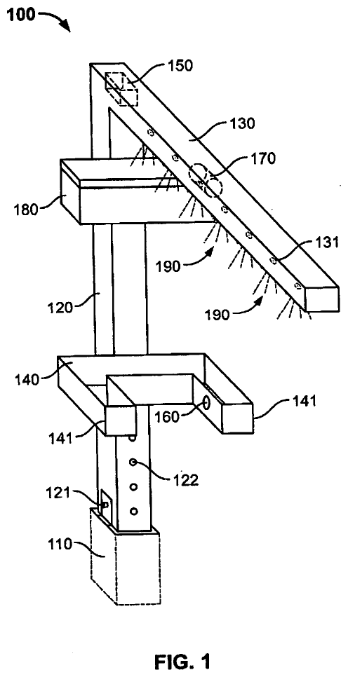

FIG. 1 illustrates a top angled perspective view of an automatic cattle wormer system 100, according to an exemplary embodiment of the present general inventive concept.

Referring to FIG. 1, the automatic cattle wormer system 100 may include a base 110, a vertical post 120, a horizontal post 130, a food basin 140, a processor 150, a sensor 160, a pump 170, a compound holding box 180, and a deworming compound 190.

The base 110 may be cemented into the ground, or may have a separate stand (not illustrated) to allow the automatic cattle wormer system 100 to sit on any surface.

The vertical post 120 may extend vertically from the base 110, and may include an on/off switch 121, and a plurality of food basin height regulators 122.

The on/off switch 121 may allow the automatic cattle wormer system 100 to be turned on and/or off, in order to cause the sensor 160 to be activated. Alternatively, the on/off switch 121 may cause the deworming compound 190 to be sprayed on an animal.

The horizontal post 130 may extend horizontally from a top portion of the vertical post 120, such that an entire cow, for example, may be covered by the horizontal post 130 when the cow is standing under the horizontal pot 130.

The horizontal post 130 may have a plurality of spouts 131 disposed on a bottom surface thereof, such that the plurality of spouts 131 may spray the animal standing below the plurality of spouts 131.

The food basin 140 may hold food for animals therein, and may include two arms 141 that allow an animal to enter a space therebetween. As such, the two arms 141 may extend horizontally from the food basin 140, and may be substantially parallel to each other.

The food basin 140 may be moved up and down the vertical post 120 using the food basin height regulators 122, which may include apertures and pins/pegs.

The processor 150 may be any type of processor, including microprocessor, known to one of ordinary skill in the art, and may be connected to and control other electronic components and/or receive messages therefrom, including, but not limited to, the sensor 160, the pump 170, and the spouts 131.

The sensor 160 may be disposed on an inner portion of at least one of the arms 141.

The sensor 160 may be, preferably, a motion sensor, which may sense when a cow, for example, has entered between the arms 141 of the food basin 140. However, the sensor 160 may also be a vibration sensor, a tactile sensor, an accelerometer-type sensor, a pressure sensor, and a temperature sensor, but is not limited thereto.

The compound holding box 180 may be disposed on at least one of the vertical post 110 and the horizontal post 130, but is not limited thereto.

The deworming compound 190 may be stored within the compound holding box 180, and may be sprayed out the spouts 131 when the sensor 160 senses that the animal has entered between the arms 141. The deworming compound 190 may be a de-wormer, an insecticide, a fly spray, or any other type of medication required by the animal, and may be in liquid or powder form.

When the sensor 160 senses that the cow has entered between the arms 141 of the food basin 140, the sensor 160 may send a signal to the processor 150 that the cow is between the arms 141. Subsequently, the processor 150 may cause the pump 170 to extract the deworming compound 190 from the compound holding box 180, and then pump the deworming compound 190 from the compound holding box 180 into each of the plurality of spouts 131, such that the deworming compound 190 sprays out of the plurality of spouts 131 onto the cow.

As such, the cow may be distracted when eating food from the food basin 140, which makes it easier for the cow to receive the deworming compound 190.

Although the on/off switch 121 is illustrated as being disposed on the vertical post 120, and the processor 150 and the pump 170 are illustrated as being disposed within the horizontal post 130, these elements/components may be disposed on and/or within any part of the automatic cattle wormer system 100.

Cables, pipes, and electrical wires have not been illustrated herein, and may be disposed throughout the automatic cattle wormer system 100.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An automatic cattle wormer system to medicate an animal, the automatic cattle wormer system comprising:
a base;
a vertical post to extend vertically from the base;
a horizontal post to extend horizontally from a top portion of the vertical post, the horizontal post comprising:
a plurality of spouts disposed on a bottom surface of the horizontal post;
a food basin to store food therein, the food basin comprising:
two arms extending horizontally from the food basin and being substantially parallel to each other, and
a sensor disposed on an inner surface of at least one of the two arms to sense when the animal has entered a space between the two arms;
a compound holding box disposed on at least one of the vertical post and the horizontal post to store a deworming compound therein; and
a pump to extract the deworming compound from the compound holding box such that the spouts spray the deworming compound out therefrom.

2. The automatic cattle wormer system of claim 1, further comprising:
a processor to receive a signal from the sensor in response to the animal walking between the two arms, and to send another signal to the pump to perform the extraction of the deworming compound from the compound holding box such that the spouts spray the deworming compound out therefrom.
